(19) United States
(12) Patent Application Publication
(10) Pub. No.: US 2022/0394949 A1
(43) Pub. Date: Dec. 15, 2022

(54) Cat Litter Collection Assembly

(71) Applicant: Nelson Howard, Escondido, CA (US)

(72) Inventor: Nelson Howard, Escondido, CA (US)

(21) Appl. No.: 17/344,925

(22) Filed: Jun. 10, 2021

(51) Int. Cl. A01K 1/01

(52) U.S. Cl. CPC A01K 1/0114

(57) ABSTRACT

A cat litter collection assembly for inhibiting cat litter from being tracked around a house includes a pan has a plurality of compartments each is integrated into the pan and a frame that is positionable around the pan. A screen is coupled to the frame such that screen covers the pan when the frame is positioned around the pan and a litter box can be positioned on the screen. The screen is comprised of a mesh material to collect the cat litter that falls from the cat's paws. A backsplash is coupled to and extends upwardly from the frame to deflect cat litter that the cat kicks when the cat is burying feces in the cat litter thereby facilitating the deflected cat litter to fall into the pan for collection.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to litter collection devices and more particularly pertains to a new litter collection device for inhibiting cat litter from being tracked around a house. The device includes a pan with a plurality of compartments and a frame that is positionable around the pan. A screen is coupled to the frame and the screen covers the pan when the frame is positioned around the pan. A litter box is positionable on the screen such that the pan captures cat litter that falls from a cat's paws when the cat exits the litter box.

### (2) Description of Related Art including information disclosed under 37 CFR 1.97 and 1.98.

The prior art relates to litter collection devices including a variety of litter collection devices that include a pan and a foraminous panel that is positionable in the pan for collecting cat litter from a cat's paws. The prior art discloses a mat with a plurality pegs extending upwardly from the mat for capturing cat litter from a cat's paws. In no instance does the prior art disclose a pan with a plurality of compartments, frame that is positionable around the pan and a screen coupled to the frame for capturing cat litter from a cat's paws.

### BRIEF SUMMARY OF THE INVENTION

An embodiment of the disclosure meets the needs presented above by generally comprising a pan has a plurality of compartments each is integrated into the pan. a frame is positionable around the pan. A screen is coupled to the frame such that screen covers the pan when the frame is positioned around the pan and a litter box can be positioned on the screen. The screen is comprised of a mesh material to collect the cat litter that falls from the cat's paws. A backsplash is coupled to and extends upwardly from the frame to deflect cat litter that the cat kicks when the cat is burying feces in the cat litter thereby facilitating the deflected cat litter to fall into the pan for collection.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a cat litter collection assembly according to an embodiment of the disclosure.

FIG. 2 is a front exploded view of an embodiment of the disclosure.

FIG. 3 is a back phantom view of an embodiment of the disclosure showing a frame positioned around a pan.

FIG. 4 is a top view of an embodiment of the disclosure.

FIG. 5 is a bottom view of an embodiment of the disclosure.

FIG. 6 is a top view of a pan of an embodiment of the disclosure.

FIG. 7 is a perspective in-use view of an embodiment of the disclosure.

FIG. 8 is an exploded perspective view of an alternative embodiment of the disclosure.

### DETAILED DESCRIPTION OF THE INVENTION

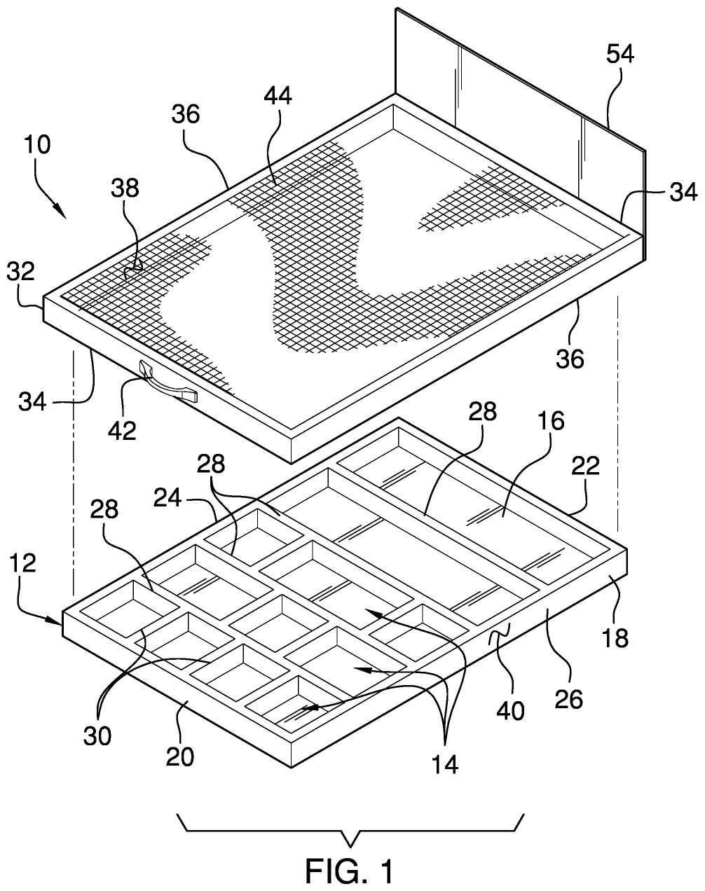

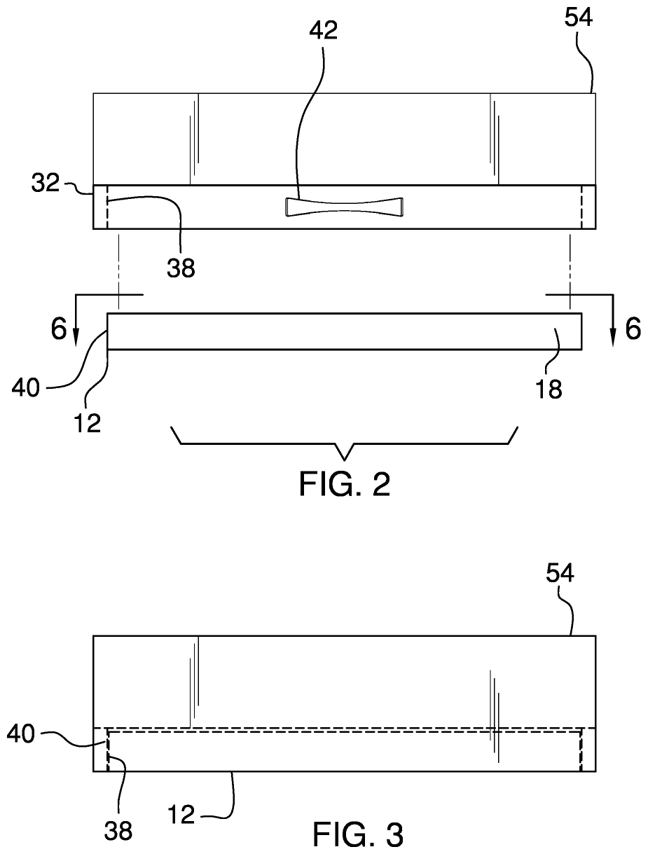

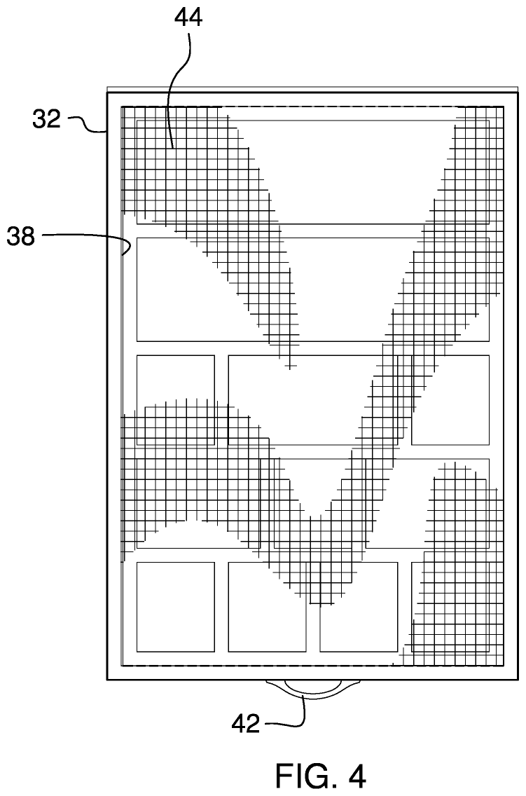

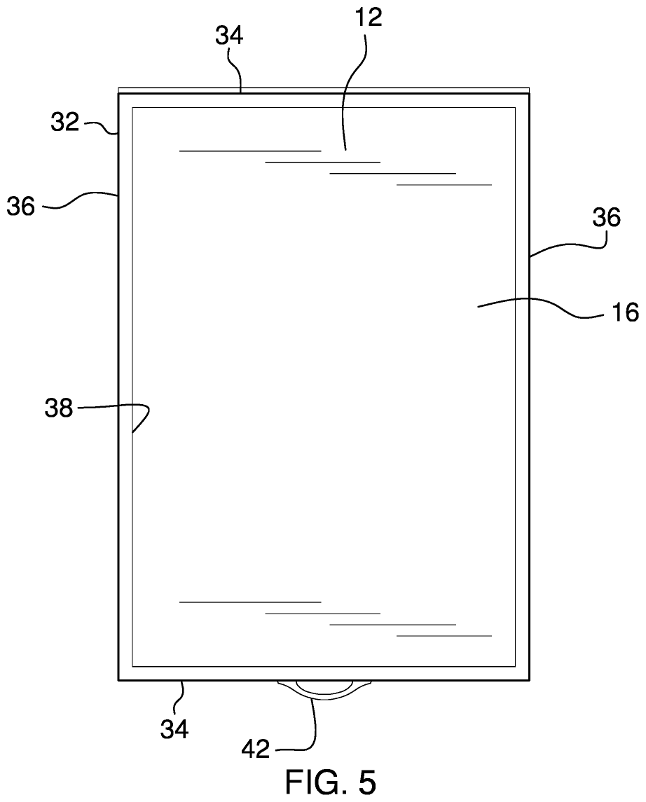

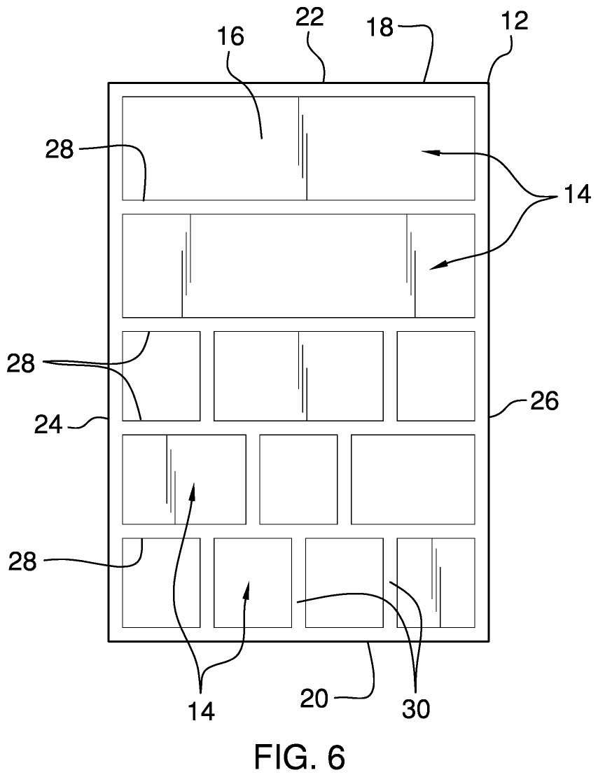

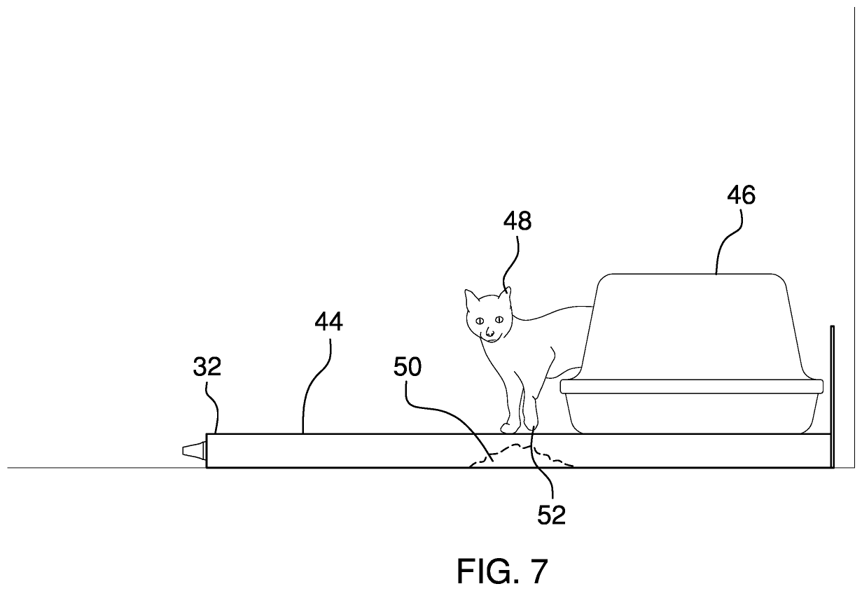

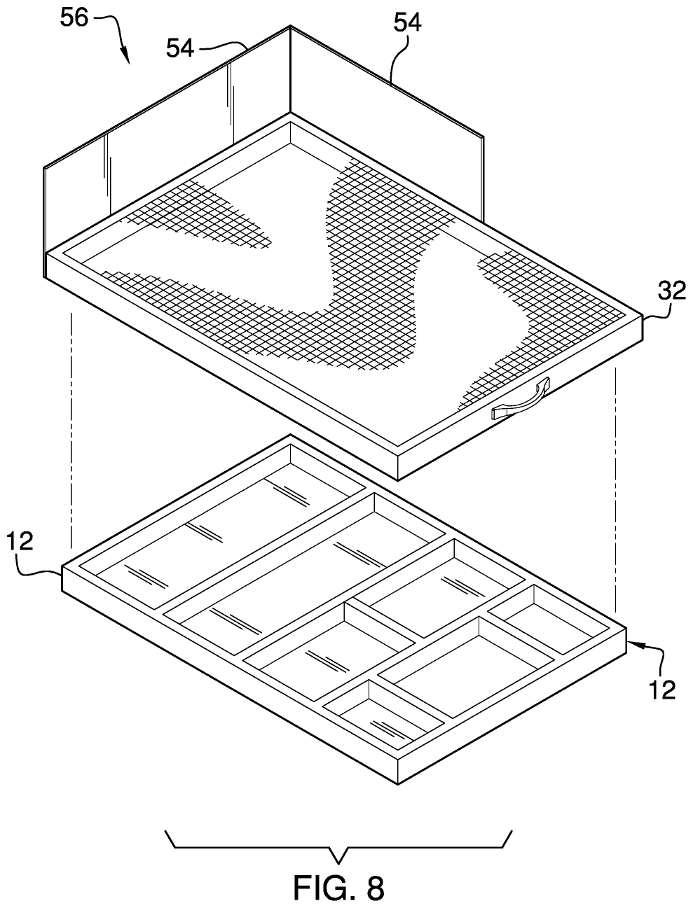

With reference now to the drawings, and in particular to FIGS. 1 through 8 thereof, a new litter collection device embodying the principles and concepts of an embodiment of the disclosure and generally designated by the reference numeral 10 will be described.

As best illustrated in FIGS. 1 through 8, the cat litter collection assembly 10 generally comprises a pan 12 that has a plurality of compartments 14 each being integrated into the pan 12. The pan 12 has a bottom wall 16 and a perimeter wall 18 extending upwardly from the bottom wall 16, and the perimeter wall 18 has a front side 20, a back side 22, a first lateral side 24 and a second lateral side 26. The pan 12 has a plurality of first dividers 28 each extending upwardly from the bottom wall 16, and each of the first dividers 28 extends between the first lateral side 24 and the second lateral side 26 of the perimeter wall 18. The first dividers 28 are spaced apart from each other and are distributed between the front side 20 and the back side 22 of the perimeter wall 18.

The pan 12 has a plurality of second dividers 30 each extending upwardly from the bottom wall 16. Each of the second dividers 30 extends between respective pairs of the first dividers 28 such that each of the first dividers 28 and each of the second dividers 30 define the plurality of compartments 14 in the pan 12. The first dividers 28 are evenly spaced apart from each other such that each of the compartments 14 has a uniform length. Additionally, the second dividers 30 are spaced apart from each other in a variety of distances such that plurality of compartments 14 has varying widths.

A frame 32 is provided and the frame 32 is positionable around the pan 12. The frame 32 has a pair of first members 34 each extending between a pair of second members 36. Additionally, the first members 34 are oriented at a right angle with the second members 36 such that the frame 32 has a rectangular shape. Each of the first members 34 and the second members 36 has an inwardly facing surface 38. Additionally, the frame 32 has a length and a width that is greater than the length and the width of the pan 12. In this way the inwardly facing surface 38 of each of the first members 34 and the second members 36 abuts an outwardly facing surface 40 of the perimeter wall 18 of the pan 12 when the frame 32 is positioned around the pan 12. A handle 42 is coupled to a respective one of the first members 34 for gripping and carrying the frame 32.

A screen 44 is coupled to the frame 32 such that screen 44 covers the pan 12 when the frame 32 is positioned around the pan 12. In this way a litter box 46 for a cat 48 can be positioned on the screen 44. The screen 44 is comprised of a mesh material wherein the screen 44 is configured to facilitate cat litter 50 that has collected on the cat's paws 52 to fall through the screen 44 when the cat 48 exits the litter box 46 thereby facilitating the pan 12 to collect the cat litter 50 that falls from the cat's paws 52. The screen 44 extends between each of the first members 34 and each of the second members 36.

A backsplash 54 is coupled to and extends upwardly from the frame 32 such that the backsplash 54 is positioned behind the litter box 46 when the litter box 46 is positioned on the screen 44. The backsplash 54 is comprised of a rigid material to deflect cat litter 50 that the cat 48 kicks when the cat 48 is burying feces in the cat litter 50. In this way the deflected cat litter 50 can fall into the pan 12 for collection. The backsplash 54 is positioned on a respective one of the first members 34 and the backsplash 54 extends along a full length of the respective first member 34. The backsplash 54 might be removable from the respective first member 34 for attaching to a respective second member 36 to accommodate various orientations of the litter box 46 on the screen 44. In an alternative embodiment 56 as is most clearly shown in FIG. 8, a plurality of backsplashes 54 may be provided and the plurality of backsplashes 54 may be distributed at various locations around the perimeter wall 18.

In use, the pan 12 is positioned at a desired location, the frame 32 is positioned over the pan 12 and the litter box 46 is positioned on the frame 32. In this way the cat 48 walks across the screen 44 when the cat 48 exits the litter box 46. The cat litter 50 that has collected on the cat's paws 52 falls through the screen 44 into the pan 12 when the cat 48 walks across the screen 44. In this way the cat 48 is inhibited from tracking cat litter 50 onto a floor of a house in which the litter box 46 is positioned. The litter box 46 is lifted from the screen 44 and the frame 32 is lifted from the pan 12 to facilitate the pan 12 to be emptied when the pan 12 becomes filled with cat litter 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cat litter collection assembly for collecting cat litter from a cat's paws when the cat exits a litter box, said assembly comprising:
a pan having a plurality of compartments each being integrated into said pan;
a frame being positionable around said pan;
a screen being coupled to said frame such that screen covers said pan when said frame is positioned around said pan wherein said screen is configured to have a litter box for a cat positioned on said screen, said screen being comprised of a mesh material wherein said screen is configured to facilitate cat litter that has collected on the cat's paws to fall through said screen when the cat exits the litter box thereby facilitating said pan to collect the cat litter that falls from the cat's paws; and
a backsplash being coupled to and extending upwardly from said frame wherein said backsplash is configured to be positioned behind the litter box when the litter box is positioned on said screen, said backsplash being comprised of a rigid material wherein said backsplash is configured to deflect cat litter that the cat kicks when the cat is burying feces in the cat litter thereby facilitating the deflected cat litter to fall into said pan for collection.

2. The assembly according to claim 1, wherein:
said pan has a bottom wall and a perimeter wall extending upwardly from said bottom wall, said perimeter wall having a front side, a back side, a first lateral side and a second lateral side;
said pan has a plurality of first dividers each extending upwardly from said bottom wall, each of said first dividers extending between said first lateral side and said second lateral side of said perimeter wall; and
said pan has a plurality of second dividers each extending upwardly from said bottom wall, each of said second dividers extending between respective pairs of said first dividers such that each of said first dividers and each of said second dividers defines said plurality of compartments in said pan.

3. The assembly according to claim 2, wherein said first dividers are spaced apart from each other and are distributed between said front side and said back side of said perimeter wall, said first dividers being evenly spaced apart from each other such that each of said compartments has a uniform length.

4. The assembly according to claim 2, wherein said second dividers are spaced apart from each other in a variety of distances such that plurality of compartments has varying widths.

5. The assembly according to claim 2, wherein said frame has a pair of first members each extending between a pair of second members, said first members being oriented at a right angle with said second members such that said frame has a rectangular shape, each of said first members and said second members having an inwardly facing surface, said frame having a length and a width being greater than the length and the width of said pan such that said inwardly facing surface of each of said first members and said second members abuts an outwardly facing surface of said perimeter wall of said pan when said frame is positioned around said pan.

6. A cat litter collection assembly for collecting cat litter from a cat's paws when the cat exits a litter box, said assembly comprising:
a pan having a plurality of compartments each being integrated into said pan, said pan having a bottom wall and a perimeter wall extending upwardly from said bottom wall, said perimeter wall having a front side, a back side, a first lateral side and a second lateral side, said pan having a plurality of first dividers each extending upwardly from said bottom wall, each of said first dividers extending between said first lateral side and said second lateral side of said perimeter wall, said first dividers being spaced apart from each other and being distributed between said front side and said back side of said perimeter wall, said pan having a plurality of second dividers each extending upwardly from said bottom wall, each of said second dividers extending between respective pairs of said first dividers such that each of said first dividers and each of said second dividers defines said plurality of compartments in said pan, said first dividers being evenly spaced apart from each other such that each of said compartments has a uniform length, said second dividers being spaced apart from each other in a variety of distances such that plurality of compartments has varying widths;
a frame being positionable around said pan, said frame having a pair of first members each extending between a pair of second members, said first members being oriented at a right angle with said second members such that said frame has a rectangular shape, each of said first members and said second members having an inwardly facing surface, said frame having a length and a width being greater than the length and the width of said pan such that said inwardly facing surface of each of said first members and said second members abuts an outwardly facing surface of said perimeter wall of said pan when said frame is positioned around said pan;
a screen being coupled to said frame such that screen covers said pan when said frame is positioned around said pan wherein said screen is configured to have a litter box for a cat positioned on said screen, said screen being comprised of a mesh material wherein said screen is configured to facilitate cat litter that has collected on the cat's paws to fall through said screen when the cat exits the litter box thereby facilitating said pan to collect the cat litter that falls from the cat's paws, said screen extending between each of said first members and each of said second members; and
a backsplash being coupled to and extending upwardly from said frame wherein said backsplash is configured to be positioned behind the litter box when the litter box is positioned on said screen, said backsplash being comprised of a rigid material wherein said backsplash is configured to deflect cat litter that the cat kicks when the cat is burying feces in the cat litter thereby facilitating the deflected cat litter to fall into said pan for collection, said backsplash being positioned on a respective one of said first members, said backsplash extending along a full length of said respective first member.

7. A cat litter collection system for collecting cat litter from a cat's paws when the cat exits a litter box, said system comprising:
a litter box having a lower wall wherein said litter box is configured to contain cat litter for a cat;
a pan having a plurality of compartments each being integrated into said pan, said pan having a bottom wall and a perimeter wall extending upwardly from said bottom wall, said perimeter wall having a front side, a back side, a first lateral side and a second lateral side, said pan having a plurality of first dividers each extending upwardly from said bottom wall, each of said first dividers extending between said first lateral side and said second lateral side of said perimeter wall, said first dividers being spaced apart from each other and being distributed between said front side and said back side of said perimeter wall, said pan having a plurality of second dividers each extending upwardly from said bottom wall, each of said second dividers extending between respective pairs of said first dividers such that each of said first dividers and each of said second dividers defines said plurality of compartments in said pan, said first dividers being evenly spaced apart from each other such that each of said compartments has a uniform length, said second dividers being spaced apart from each other in a variety of distances such that plurality of compartments has varying widths;
a frame being positionable around said pan, said frame having a pair of first members each extending between a pair of second members, said first members being oriented at a right angle with said second members such that said frame has a rectangular shape, each of said first members and said second members having an inwardly facing surface, said frame having a length and a width being greater than the length and the width of said pan such that said inwardly facing surface of each of said first members and said second members abuts an outwardly facing surface of said perimeter wall of said pan when said frame is positioned around said pan;
a screen being coupled to said frame such that screen covers said pan when said frame is positioned around said pan, said litter box being positionable on said screen when frame is positioned around said pan, said screen being comprised of a mesh material wherein said screen is configured to facilitate cat litter that has collected on the cat's paws to fall through said screen when the cat exits said litter box thereby facilitating said pan to collect the cat litter that falls from the cat's paws, said screen extending between each of said first members and each of said second members; and
a backsplash being coupled to and extending upwardly from said frame such that said backsplash is positioned behind said litter box when said litter box is positioned on said screen, said backsplash being comprised of a rigid material wherein said backsplash is configured to deflect cat litter that the cat kicks when the cat is burying feces in the cat litter thereby facilitating the deflected cat litter to fall into said pan for collection, said backsplash being positioned on a respective one of said first members, said backsplash extending along a full length of said respective first member.
